(19) United States
(12) Patent Application Publication
(10) Pub. No.: US 2026/0321975 A1
(43) Pub. Date: Oct. 15, 2026

(54) MONOPOLE DUAL-BAND ANTENNA

(71) Applicants: Yun-Chan TSAI, Taipei City (TW); ONEWAVE TECHNOLOGY CO., LTD., Taipei City (TW)

(72) Inventors: Yun-Chan TSAI, Taipei City (TW); Shi-Yu CHIU, Taipei City (TW); Shi-Hong YANG, Taipei City (TW); Chin-Yun HSU, Taipei City (TW); Chien-Ku KUO, Taipei City (TW)

(73) Assignees: Yun-Chan TSAI, Taipei City (TW); ONEWAVE TECHNOLOGY CO., LTD., Taipei City (TW)

(21) Appl. No.: 19/176,293

(22) Filed: Apr. 11, 2025

(51) Int. Cl. H01Q 5/335; H01Q 9/30

(52) U.S. Cl. CPC H01Q 5/335; H01Q 9/30

(57) ABSTRACT

A monopole dual-band antenna includes: an antenna structure, a mainboard, a solder pad, and a signal feed layer. The antenna structure includes: a circuit board, and a high-frequency radiation layer, a low-frequency radiation layer, a conductive metal layer, and a half-hole electrode layer arranged on the circuit board. One end of the conductive metal layer is electrically connected to the high-frequency radiation layer; other end is electrically connected to the low-frequency radiation layer. The half-hole electrode layer is through a bottom surface of the circuit board to be electrically connected to the high-frequency radiation layer. The half-hole electrode layer is electrically fixedly connected to the solder pad and the signal feed layer. After a signal is fed in, two current paths are generated simultaneously, flowing through the high-frequency radiation layer and the low-frequency radiation layer respectively.

### BACKGROUND OF THE DISCLOSURE

### Technical Field

The present disclosure relates to an antenna, and especially relates to a monopole dual-band antenna in which an antenna structure is soldered to a mainboard in a side-standing manner.

### Description of Related Art

With the popularity of the Internet, people have become increasingly dependent on the Internet, and more and more Internet-connected apparatuses have been developed, such as Wi-Fi products, network communication products, Internet of Things, webcams, IP cameras, routers, or modems. Most of the antenna structures used in these apparatuses use etching technology to produce different radiation layer patterns on the copper foil on the circuit board for signal reception and transmission.

However, a high-frequency radiation layer and a low-frequency radiation layer are formed on the circuit board. There is a coupling gap between the high-frequency radiation layer and the low-frequency radiation layer. The coupling gap may shorten the low-frequency current path, reduce the size of the antenna structure, and also adjust the impedance, the operating bandwidth, and the efficiency of the antenna.

Since the antenna structure includes a coupling gap between the high-frequency radiation layer and the low-frequency radiation layer, although the coupling gap may shorten the low-frequency current path and reduce the size of the antenna structure, when manufacturing the antenna structure, the size of the coupling gap between the high-frequency radiation layer and the low-frequency radiation layer may not be easily adjusted. Therefore, if the coupling gap is not adjusted properly, the efficiency of the antenna is reduced, which causes difficulties in manufacturing the antenna structure.

Therefore, how to make the antenna easier to manufacture, shorten the low-frequency current path, and reduce the size of the antenna, is the main issue addressed by the present disclosure.

### SUMMARY OF THE INVENTION

Therefore, the main object of the present disclosure is to solve the traditional deficiencies. The present disclosure redesigns the antenna structure so that the high-frequency radiation layer and the low-frequency radiation layer of the antenna are electrically connected through a conductive metal layer, making the antenna easier to manufacture, shortening the low-frequency current path, and reducing the size of the antenna.

In order to achieve the object mentioned above, the present disclosure provides a monopole dual-band antenna which includes: an antenna structure, a mainboard, a solder pad, and a signal feed layer. The antenna structure includes: a circuit board, a high-frequency radiation layer, a low-frequency radiation layer, a conductive metal layer, and at least one half-hole electrode layer. The circuit board is a square body with a front surface, a back surface, a top surface, a bottom surface, and two side surfaces. The high-frequency radiation layer is arranged on the front surface of the circuit board. The low-frequency radiation layer is arranged on the back surface of the circuit board. The conductive metal layer is arranged on the top surface of the circuit board. One end of the conductive metal layer is electrically connected to the high-frequency radiation layer. Other end of the conductive metal layer is electrically connected to the low-frequency radiation layer. The at least one half-hole electrode layer is respectively arranged on the bottom surface of the circuit board and through the bottom surface to be electrically connected to the high-frequency radiation layer which is arranged on the front surface. The solder pad and the signal feed layer are arranged on the mainboard. Moreover, the at least one half-hole electrode layer is electrically fixedly connected to the solder pad and the signal feed layer. After a signal is fed in, two current paths are generated simultaneously, flowing through the high-frequency radiation layer and the low-frequency radiation layer respectively.

In an embodiment of the present disclosure, the high-frequency radiation layer includes a trapezoidal metal layer and an edge metal layer which is electrically connected to the trapezoidal metal layer. The edge metal layer extends along an intersection of the front surface and one of the two side surfaces to an intersection of the top surface and the front surface of the circuit board.

In an embodiment of the present disclosure, the low-frequency radiation layer is a side metal line segment. The side metal line segment follows an intersection of the top surface and the back surface of the circuit board, and extends from an intersection of one of the two side surfaces and the back surface to an intersection of the other one of the two side surfaces and the back surface of the circuit board.

In an embodiment of the present disclosure, one end of the conductive metal layer is electrically connected to the edge metal layer of the high-frequency radiation layer.

In an embodiment of the present disclosure, one end of the at least one half-hole electrode layer is electrically connected to the trapezoidal metal layer on the front surface of the circuit board.

In an embodiment of the present disclosure, the at least one half-hole electrode layer is semicircular, semielliptical, or polygonal.

In an embodiment of the present disclosure, the monopole dual-band antenna further includes an electrode layer arranged on the back surface of the circuit board and located at an intersection of the bottom surface and the back surface. The electrode layer includes a first electrode layer and a second electrode layer. The first electrode layer and the second electrode layer are electrically connected to the at least one half-hole electrode layer.

In an embodiment of the present disclosure, the monopole dual-band antenna further includes a first ground layer, a second ground layer, a first clearance area, and a second clearance area. The mainboard includes a front face and a back face. The first ground layer and the first clearance area are arranged on the front face of the mainboard. The second ground layer and the second clearance area are arranged on the back face of the mainboard. The first ground layer and the second ground layer are symmetrical. The first clearance area and the second clearance area are symmetrical. The solder pad is arranged on the first clearance area on the mainboard. The solder pad includes a first solder pad and a second solder pad.

In an embodiment of the present disclosure, shapes of the first solder pad and the second solder pad of the solder pad are H shapes or Roman numeral II shapes.

In an embodiment of the present disclosure, the signal feed layer is arranged on the front face of the mainboard and coupled to the first ground layer; the signal feed layer includes a first signal feed layer and a second signal feed layer.

In an embodiment of the present disclosure, the monopole dual-band antenna further includes a plurality of solder points and a plurality of matching components. The solder points are arranged on the first signal feed layer, the second signal feed layer, the first ground layer, and the solder pad respectively, so that the matching components are electrically connected to the solder points between the first signal feed layer and the second signal feed layer, and each of the solder points between the first signal feed layer, the second signal feed layer, the solder pad, and the first ground layer.

In an embodiment of the present disclosure, the matching components are inductors or capacitors.

In an embodiment of the present disclosure, the monopole dual-band antenna further includes a half-hole metal layer arranged on the top surface. One end of the half-hole metal layer is electrically connected to the high-frequency radiation layer. Other end of the half-hole metal layer is electrically connected to the low-frequency radiation layer.

In an embodiment of the present disclosure, the monopole dual-band antenna further includes a perforated metal layer arranged on the circuit board and through the circuit board, so that one end of the perforated metal layer is electrically connected to the high-frequency radiation layer, and other end of the perforated metal layer is electrically connected to the low-frequency radiation layer.

### BRIEF DESCRIPTION OF THE DRAWINGS

FIG. 1 shows an exploded schematic diagram of the antenna structure and the mainboard of the first embodiment of the present disclosure.

FIG. 2 shows an exploded schematic diagram of the antenna structure and the mainboard from another angle of view of FIG. 1.

FIG. 3 shows a three-dimensional assembly schematic diagram of FIG. 1.

FIG. 4 shows a three-dimensional assembly schematic diagram of FIG. 2.

FIG. 5 shows an exploded schematic diagram of the antenna structure and the mainboard of the second embodiment of the present disclosure.

FIG. 6 shows an exploded schematic diagram of the antenna structure and the mainboard from another angle of view of FIG. 5.

FIG. 7 shows an exploded schematic diagram of the antenna structure and the mainboard of the third embodiment of the present disclosure.

FIG. 8 shows an exploded schematic diagram of the antenna structure and the mainboard from another angle of view of FIG. 7.

### DETAILED DESCRIPTION

The technical content and the detailed description of the present disclosure are now explained with the drawings as follows.

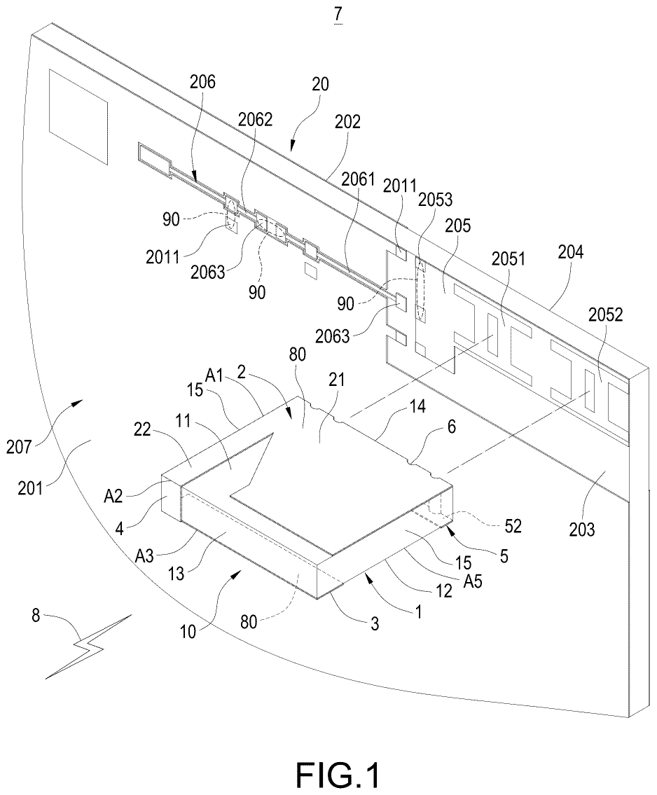

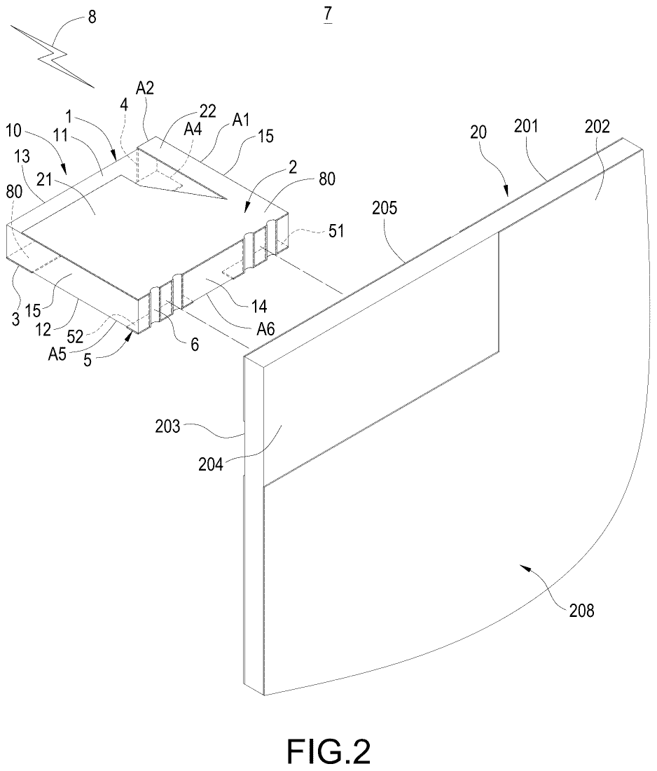

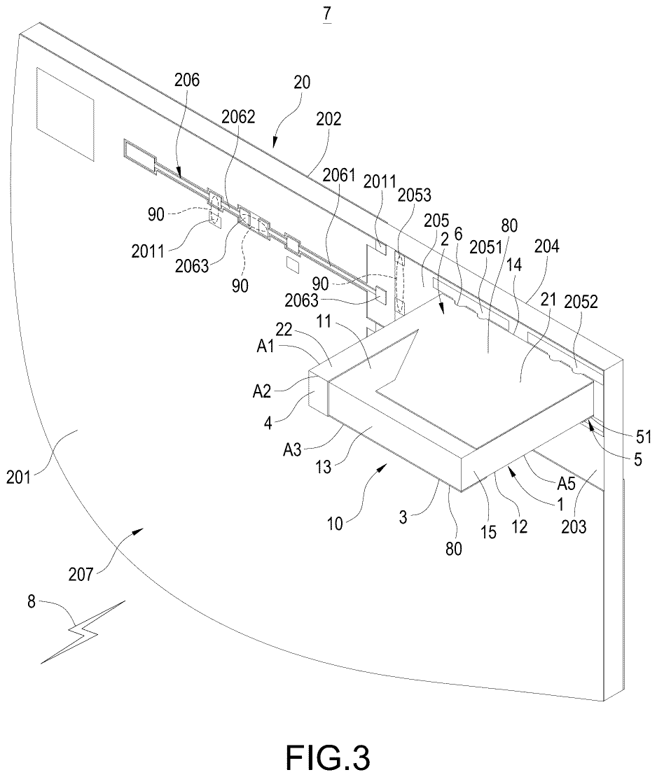

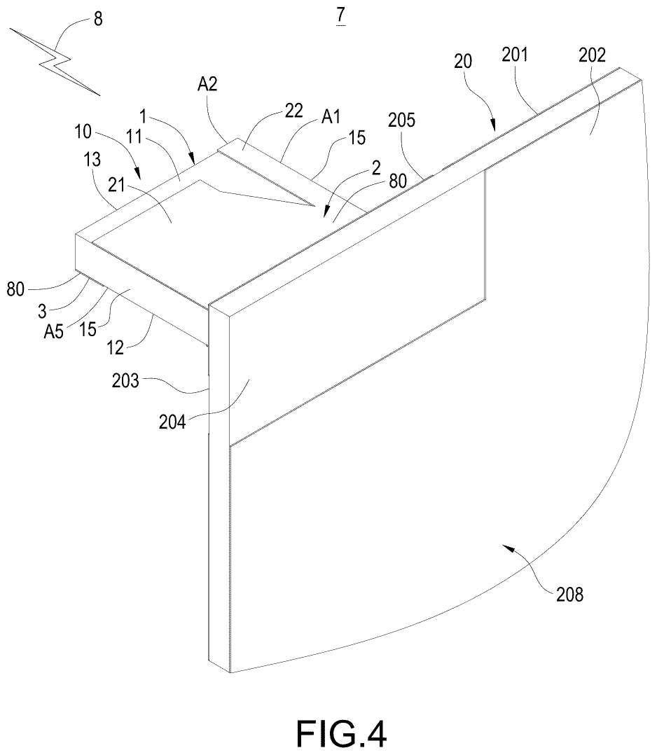

FIG. 1 shows an exploded schematic diagram of the antenna structure and the mainboard of the first embodiment of the present disclosure. FIG. 2 shows an exploded schematic diagram of the antenna structure and the mainboard from another angle of view of FIG. 1. FIG. 3 shows a three-dimensional assembly schematic diagram of FIG. 1. FIG. 4 shows a three-dimensional assembly schematic diagram of FIG. 2. As shown in the figures: the monopole dual-band antenna 7 of the present disclosure includes an antenna structure 10 and a mainboard 20. The antenna structure 10 includes: a circuit board 1, a high-frequency radiation layer 2, a low-frequency radiation layer 3, a conductive metal layer 4, an electrode layer 5, and at least one half-hole electrode layer 6.

The circuit board 1 is a square body with a front surface 11, a back surface 12, a top surface 13, a bottom surface 14, and two side surfaces 15. In the figures, the circuit board 1 is a printed circuit board.

The high-frequency radiation layer 2 is arranged on the front surface 11 of the circuit board 1. The high-frequency radiation layer 2 includes a trapezoidal metal layer 21 and an edge metal layer 22 which is electrically connected to the trapezoidal metal layer 21. The edge metal layer 22 extends along an intersection A1 of the front surface 11 and one of the two side surfaces 15 to an intersection A2 of the top surface 13 and the front surface 11.

The low-frequency radiation layer 3 is arranged on the back surface 12 of the circuit board 1. The low-frequency radiation layer 3 is a side metal line segment, which follows an intersection A3 of the top surface 13 and the back surface 13, and extends from an intersection A4 of one of the two side surfaces 15 and the back surface 12 to an intersection A5 of the other one of the two side surfaces 15 and the back surface 12 of the circuit board 1.

It is worth mentioning that the high-frequency radiation layer 2 and the low-frequency radiation layer 3 are electrically connected together. When a signal 8 is fed in, two current paths 80 are generated simultaneously. One long current path of the two current paths 80 flows/is through the low-frequency radiation layer 3 to generate a low-frequency 2.4G frequency band. One short current path of the two current paths 80 flows/is through the trapezoidal metal layer 21 and the edge metal layer 22 of the high-frequency radiation layer 2 to generate a high-frequency 5G-6G frequency band. Since the high-frequency radiation layer 2 includes the trapezoidal metal layer 21 with a wide and large area, a bandwidth of the antenna structure 10 may be increased.

The conductive metal layer 4 is arranged on the top surface 13. One end of the conductive metal layer 4 is electrically connected to the edge metal layer 22 of the high-frequency radiation layer 2. Other end of the conductive metal layer 4 is electrically connected to the low-frequency radiation layer 3. After the signal 8 is fed in, the two current paths 80 may be generated simultaneously.

The electrode layer 5 is arranged on the back surface 12 of the circuit board 1 and is located at an intersection A6 of the bottom surface 14 and the back surface 12. The electrode layer 5 includes: a first electrode layer 51 and a second electrode layer 52. The first electrode layer 51 and the second electrode layer 52 are used to provide a first solder pad 2051 and a second solder pad 2052 on the mainboard 20 with electrical connections.

The half-hole electrode layer 6 is arranged on the bottom surface 14 of the circuit board 1 and is through the bottom surface 14 of the circuit board 1, so that one end of the half-hole electrode layer 6 is electrically connected to the trapezoidal metal layer 21 of the high-frequency radiation layer 2 on the front surface 11 of the circuit board 1. Other end of the half-hole electrode layer 6 is electrically connected to a first electrode layer 51 and a second electrode layer 52 of the electrode layer 5 on the back surface 12. In the figures, the half-hole electrode layer 6 is semicircular, semielliptical, or polygonal.

It is worth mentioning that the design of the half-hole electrode layer 6 is to reduce the manufacturing cost of the antenna structure 10 and to electrically fixedly connect the antenna structure 10 to the first solder pad 2051 and the second solder pad 2052 of the solder pad 205 on the mainboard 20 without damaging the original structure of the mainboard 20.

The antenna structure 10 of the present disclosure is used with the mainboard 20 of an electronic apparatus. The monopole dual-band antenna 7 further includes a first ground layer 201, a second ground layer 202, a first clearance area 203, a second clearance area 204, and a solder pad 205. The mainboard 20 includes a front face 207 and a back face 208. The first ground layer 201 and the first clearance area 203 are arranged on the front face 207 of the mainboard 20. The second ground layer 202 and the second clearance area 204 are arranged on the back face 208 of the mainboard 20. The first ground layer 201 and the second ground layer 202 are symmetrical. The first clearance area 203 and the second clearance area 204 are symmetrical. The solder pad 205 is arranged on the first clearance area 203 on the mainboard 20. The solder pad 205 includes a first solder pad 2051 and a second solder pad 2052.

In addition, the monopole dual-band antenna 7 further includes a signal feed layer 206 which is arranged on the front surface 207 of the mainboard 20 and coupled to the first ground layer 201. The signal feed layer 206 includes a first signal feed layer 2061 and a second signal feed layer 2062. The monopole dual-band antenna 7 further includes a plurality of solder points 2063, 2011, 2053 and a plurality of matching components 90. The solder points 2063, 2011, 2053 are arranged on the signal feed layer 206, the first ground layer 201, and the solder pad 205 respectively, so that the matching components 90 are electrically connected to each of the solder points 2063, 2011, 2053 between the first signal feed layer 2061, the second signal feed layer 2062, the solder pad 205, and the first ground layer 201. The matching components 90 adjust the impedance and frequency characteristics of the antenna structure 10. In the figures, shapes of the first solder pad 2051 and the second solder pad 2052 of the solder pad 205 are H shapes or Roman numeral II shapes.

It is worth mentioning that the present disclosure discloses that the matching components 90 electrically connected to the solder points 2063 between the first signal feed layer 2061 and the second signal feed layer 2062 of the signal feed layer 206, and each of the solder points 2063, 2053, 2011 between the first signal feed layer 2061, the second signal feed layer 2062, the solder pad 205, and the first ground layer 201, are inductors or capacitors. The impedance and the frequency characteristics of the antenna structure 10 may be adjusted during production, so that the impedance and the frequency characteristics of the antenna structure 10 may be adjusted to match the used electronic product.

Because the signal 8 mentioned above is fed into the antenna structure 10 from/through the signal feed layer 206, the two current paths 80 are generated simultaneously. The long current path of the two current paths 80 flows/is through the low-frequency radiation layer 3 to generate the low-frequency 2.4G frequency band. The short current path of the two current paths 80 flows/is through the trapezoidal metal layer 21 and the edge metal layer 22 of the high-frequency radiation layer 2 to generate the high-frequency 5G-6G frequency band. Since the high-frequency radiation layer 2 includes the trapezoidal metal layer 21 with the wide and large area, the bandwidth of the antenna structure 10 may be increased. The antenna structure 10 may generate the two current paths 80 simultaneously, and may quickly switch a speed of the high frequency or the low frequency in transmitting and receiving the signal 8, making the antenna structure 10 more stable in the performance and gain of transmitting and receiving the signal 8.

In addition, due to the design of the solder pad 205 arranged on the mainboard 20, the soldering stability and solidity of the antenna structure 10 may be increased, preventing the antenna structure 10 from shifting during production using surface mount technology (SMT). The solder pad 205 may also be increased to firmly grasp or fix the body of the antenna structure 10, thereby improving the problem of detaching when dropped.

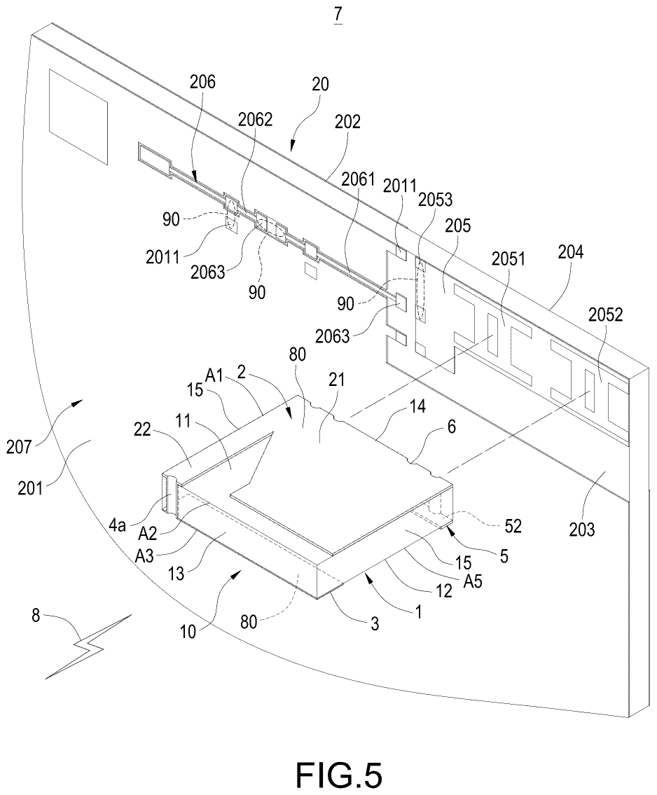

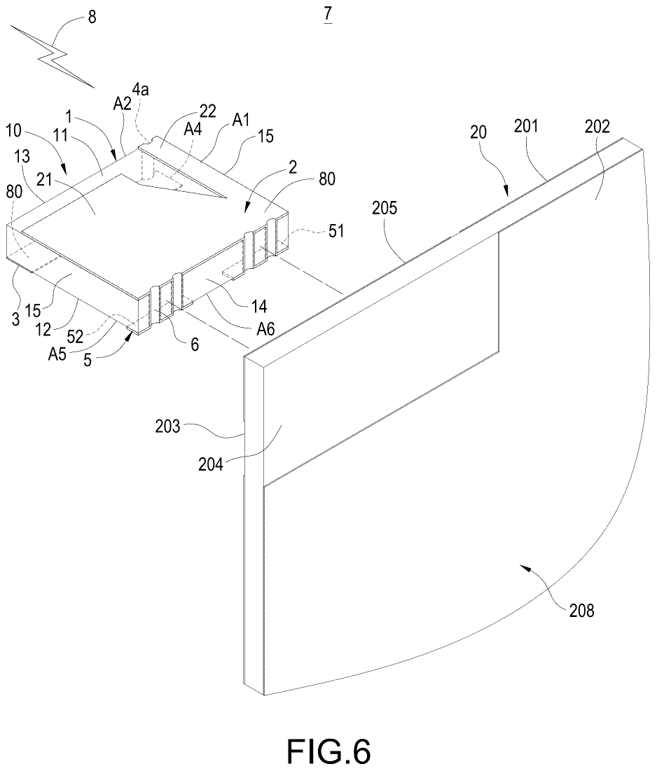

FIG. 5 shows an exploded schematic diagram of the antenna structure and the mainboard of the second embodiment of the present disclosure. FIG. 6 shows an exploded schematic diagram of the antenna structure and the mainboard from another angle of view of FIG. 5. Also refer to FIG. 1 to FIG. 4. As shown in the figures: the antenna structure 10 and the mainboard 20 of this embodiment are roughly the same as those of the first embodiment. The difference is that the conductive metal layer 4 of the antenna structure 10 may be designed as a half-hole metal layer 4a. The half-hole metal layer 4a is arranged on the top surface 13 of the circuit board 1. One end of the half-hole metal layer 4a is electrically connected to the edge metal layer 22 of the high-frequency radiation layer 2. Other end of the half-hole metal layer 4a is electrically connected to the low-frequency radiation layer 3. After the signal 8 is fed in, the two current paths 80 may be generated simultaneously.

The two current paths 80 are respectively the long current path and the short current path. The long current path of the two current paths 80 flows/is through the low-frequency radiation layer 3 to generate the low-frequency 2.4G frequency band. The short current path of the two current paths 80 flows/is through the trapezoidal metal layer 21 and the edge metal layer 22 of the high-frequency radiation layer 2 to generate the high-frequency 5G-6G frequency band. Since the high-frequency radiation layer 2 includes the trapezoidal metal layer 21 with the wide and large area, the bandwidth of the antenna structure 10 may be increased. The antenna structure 10 may generate the two current paths 80 simultaneously, and may quickly switch the speed of the high frequency or the low frequency in transmitting and receiving the signal 8, making the antenna structure 10 more stable in the performance and gain of transmitting and receiving the signal 8.

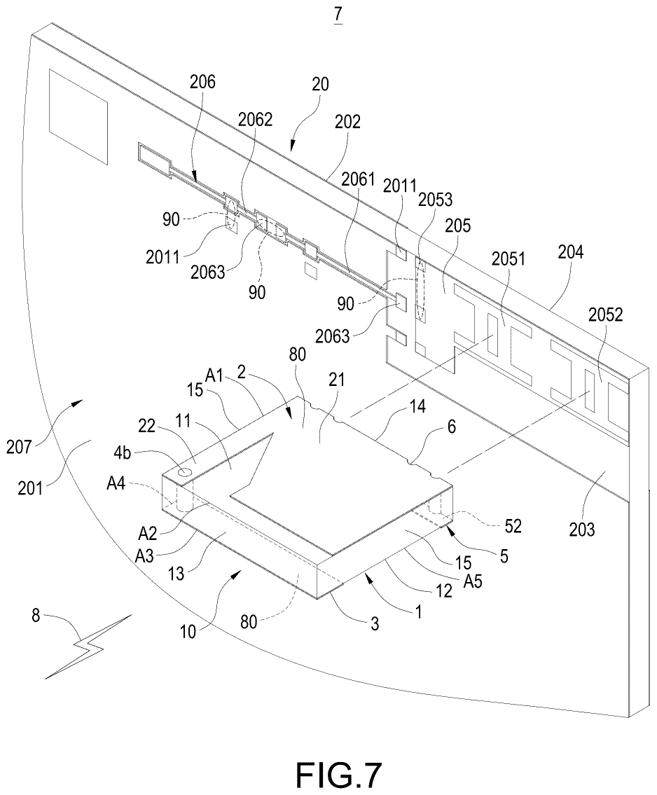

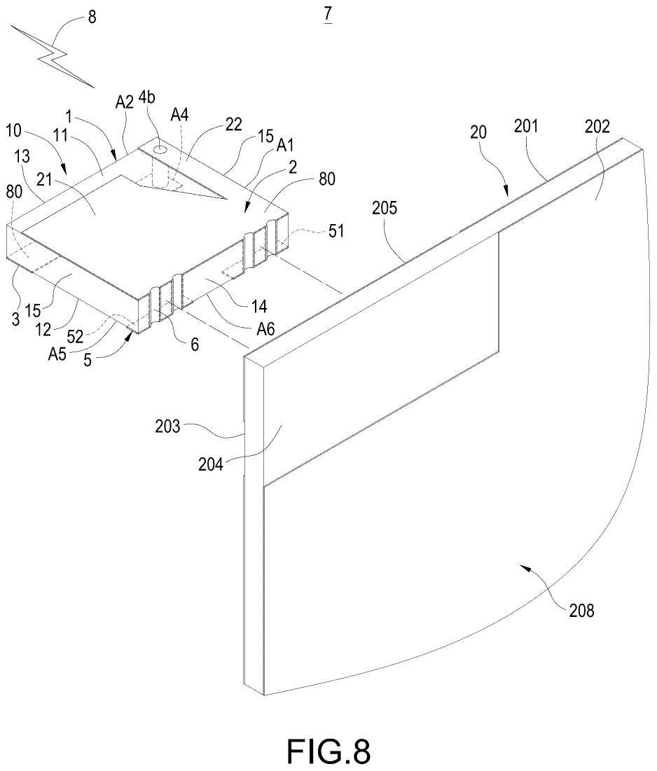

FIG. 7 shows an exploded schematic diagram of the antenna structure and the mainboard of the third embodiment of the present disclosure. FIG. 8 shows an exploded schematic diagram of the antenna structure and the mainboard from another angle of view of FIG. 7. Also refer to FIG. 1 to FIG. 6. As shown in the figures: the antenna structure 10 and the mainboard 20 of this embodiment are roughly the same as those of the first and second embodiments. The difference is that the conductive metal layer 4 or the half-hole metal layer 4a of the antenna structure 10 may be designed as a perforated metal layer 4b. The perforated metal layer 4b is directly through the circuit board 1, so that one end of the perforated metal layer 4b is electrically connected to the edge metal layer 22 of the high-frequency radiation layer 2, and other end of the perforated metal layer 4b is electrically connected to the low-frequency radiation layer 3. After the signal 8 is fed in, the two current paths 80 are also generated simultaneously.

The two current paths 80 are respectively the long current path and the short current path. The long current path of the two current paths 80 flows/is through the low-frequency radiation layer 3 to generate the low-frequency 2.4G frequency band. The short current path of the two current paths 80 flows/is through the trapezoidal metal layer 21 and the edge metal layer 22 of the high-frequency radiation layer 2 to generate the high-frequency 5G-6G frequency band. Since the high-frequency radiation layer 2 includes the trapezoidal metal layer 21 with the wide and large area, the bandwidth of the antenna structure 10 may be increased. The antenna structure 10 may generate the two current paths 80 simultaneously, and may quickly switch the speed of the high frequency or the low frequency in transmitting and receiving the signal 8, making the antenna structure 10 more stable in the performance and gain of transmitting and receiving the signal 8.

However, the above descriptions are only preferred embodiments of the present disclosure and are not intended to limit the scope of the patent protection of the present disclosure. Therefore, any equivalent changes made by using the contents of the specifications or the drawings of the present disclosure are equally included in the scope of the patent protection of the present disclosure and are hereby stated.

What is claimed is:

1. A monopole dual-band antenna, comprising an antenna structure, a mainboard, a solder pad, and a signal feed layer,
wherein the antenna structure comprises:
a circuit board, being a square body with a front surface, a back surface, a top surface, a bottom surface, and two side surfaces;
a high-frequency radiation layer, arranged on the front surface of the circuit board;
a low-frequency radiation layer, arranged on the back surface of the circuit board;
a conductive metal layer, arranged on the top surface of the circuit board, one end of the conductive metal layer electrically connected to the high-frequency radiation layer, other end of the conductive metal layer electrically connected to the low-frequency radiation layer; and
at least one half-hole electrode layer, respectively arranged on the bottom surface of the circuit board and through the bottom surface to be electrically connected to the high-frequency radiation layer arranged on the front surface,
wherein the at least one half-hole electrode layer is electrically fixedly connected to the solder pad and the signal feed layer; after a signal is fed in, two current paths are generated simultaneously, flowing through the high-frequency radiation layer and the low-frequency radiation layer respectively.

2. The monopole dual-band antenna of the claim 1, wherein the high-frequency radiation layer comprises a trapezoidal metal layer and an edge metal layer electrically connected to the trapezoidal metal layer; the edge metal layer extends along an intersection of the front surface and one of the two side surfaces to an intersection of the top surface and the front surface of the circuit board.

3. The monopole dual-band antenna of the claim 2, wherein the low-frequency radiation layer is a side metal line segment; the side metal line segment follows an intersection of the top surface and the back surface of the circuit board, and extends from an intersection of one of the two side surfaces and the back surface to an intersection of the other one of the two side surfaces and the back surface of the circuit board.

4. The monopole dual-band antenna of the claim 3, wherein one end of the conductive metal layer is electrically connected to the edge metal layer of the high-frequency radiation layer.

5. The monopole dual-band antenna of the claim 4, wherein one end of the at least one half-hole electrode layer is electrically connected to the trapezoidal metal layer on the front surface of the circuit board.

6. The monopole dual-band antenna of the claim 5, wherein the at least one half-hole electrode layer is semicircular, semielliptical, or polygonal.

7. The monopole dual-band antenna of the claim 5, further comprising an electrode layer, arranged on the back surface of the circuit board and located at an intersection of the bottom surface and the back surface; the electrode layer comprises a first electrode layer and a second electrode layer; the first electrode layer and the second electrode layer are electrically connected to the at least one half-hole electrode layer.

8. The monopole dual-band antenna of the claim 7, further comprising a first ground layer, a second ground layer, a first clearance area, and a second clearance area, wherein the mainboard comprises a front face and a back face; the first ground layer and the first clearance area are arranged on the front face of the mainboard; the second ground layer and the second clearance area are arranged on the back face of the mainboard; the first ground layer and the second ground layer are symmetrical; the first clearance area and the second clearance area are symmetrical;
the solder pad is arranged on the first clearance area on the mainboard; the solder pad comprises a first solder pad and a second solder pad.

9. The monopole dual-band antenna of the claim 8, wherein shapes of the first solder pad and the second solder pad of the solder pad are H shapes or Roman numeral II shapes.

10. The monopole dual-band antenna of the claim 8, wherein the signal feed layer is arranged on the front face of the mainboard and coupled to the first ground layer; the signal feed layer comprises a first signal feed layer and a second signal feed layer.

11. The monopole dual-band antenna of the claim 10, further comprising a plurality of solder points and a plurality of matching components; the solder points are arranged on the first signal feed layer, the second signal feed layer, the first ground layer, and the solder pad respectively, so that the matching components are electrically connected to the solder points between the first signal feed layer and the second signal feed layer, and each of the solder points between the first signal feed layer, the second signal feed layer, the solder pad, and the first ground layer.

12. The monopole dual-band antenna of the claim 11, wherein the matching components are inductors or capacitors.

13. The monopole dual-band antenna of the claim 1, further comprising a half-hole metal layer, arranged on the top surface, one end of the half-hole metal layer electrically connected to the high-frequency radiation layer, other end of the half-hole metal layer electrically connected to the low-frequency radiation layer.

14. The monopole dual-band antenna of the claim 1, further comprising a perforated metal layer, arranged on the circuit board and through the circuit board, so that one end of the perforated metal layer is electrically connected to the high-frequency radiation layer, and other end of the perforated metal layer is electrically connected to the low-frequency radiation layer.
